(19) United States
(12) Patent Application Publication
(10) Pub. No.: US 2018/0349280 A1
(43) Pub. Date: Dec. 6, 2018

(54) SNOOP FILTERING FOR MULTI-PROCESSOR-CORE SYSTEMS

(71) Applicant: Oracle International Corporation, Redwood City, CA (US)

(72) Inventors: Bipin Prasad, Austin, TX (US); John Fernando, Austin, TX (US); Benjamin Michelson, Austin, TX (US)

(21) Appl. No.: 15/613,102

(22) Filed: Jun. 2, 2017

(51) Int. Cl. G06F 12/0831; G06F 9/30; G06F 9/38; G06F 12/0808; G06F 12/128

(52) U.S. Cl. CPC G06F 12/0831; G06F 9/30047; G06F 9/3804; G06F 2212/69; G06F 12/128; G06F 2212/621; G06F 12/0808

(57) ABSTRACT

Techniques are disclosed relating to cache coherency and snoop filtering. In some embodiments, an apparatus includes multiple processor cores and corresponding filter circuitry that is configured to filter snoops to the processor cores. The filter circuitry may implement a Bloom filter. The filter circuitry may include a first set of counters. The filter circuitry may determine a group of counters in the first set based on applying multiple hash functions to an incoming address. For allocations, the filter circuitry may increment the counters in the corresponding group of counters; for evictions, the filter circuitry may decrement the counters in the corresponding group of counters; and for snoops, the filter circuitry may determine whether to filter the snoop based on whether any of the counters in the corresponding group are at a start value. In some embodiments, the apparatus further includes overflow circuitry and is configured to allocate an overflow counter to continue counting for a saturated counter in the first set of counters.

### BACKGROUND

### Field of the Invention

This invention relates to computing systems, and more particularly to cache coherency and snoop filtering.

### Description of the Related Art

Microprocessors often include multiple cores, each of which may have one or more corresponding caches at one or more different levels in a cache/memory hierarchy. Further, as greater numbers of processors are included in multi-processor systems, the number of caches in the system increases. Cache coherence techniques maintain a coherent view of data values in multiple caches (e.g., such that other processors with a given cache line have knowledge of changes to the cache line to avoid incoherent data). Snooping is a well-known technique for determining when data needs to updated or invalidated based on changes by other processor cores. As the number of cores grows, circuitry for implementing cache coherence may become complex and use significant area and power consumption.

### SUMMARY

Techniques are disclosed relating to cache coherency and snoop filtering. In some embodiments, an apparatus includes multiple processor cores and corresponding filter circuitry that is configured to filter snoops to the processor cores (which may be a sub-set of the cores in a system, such that the filter circuitry may filter snoop requests from external processor cores). In some embodiments, the filter circuitry implements a Bloom filter. The filter circuitry may include a first set of counters each having a first number of bits. The filter circuitry may determine a group of counters based on applying multiple hash functions to an incoming address. Depending on the operation associated with the address (e.g., a cache line allocation, eviction, or snoop), the filter circuitry may handle the counters differently. For allocations, the filter circuitry may increment the counters in the corresponding group of counters; for evictions, the filter circuitry may decrement the counters in the corresponding group of counters; and for snoops, the filter circuitry may determine whether to filter the snoop based on whether any of the counters in the corresponding group are at a start value.

In some embodiments, the apparatus further includes overflow circuitry with a second set of counters that each have a greater number of bits than the counters in the first set of counters. In some embodiments, the second set of counters is significantly smaller in number than the first set of counters. In some embodiments, the apparatus is configured to allocate an overflow counter in the second set of counters to continue counting for a saturated counter in the first set of counters. The apparatus may increment the overflow counter in response to a cache block allocation when the saturated counter is saturated and decrement the overflow counter in response to a cache block eviction when the saturated counter is saturated.

In various embodiments, the disclosed overflow techniques may allow use of smaller counters in the filter circuitry, relative to implementations without overflow circuitry. This may reduce power consumption and area, in some embodiments. This may also improve performance, in some embodiments, because a cache block allocation when a corresponding counter is saturated may require flushing of caches and resetting of the filter circuitry, in some embodiments, which may be reduced using a smaller set of larger overflow counters.

In some embodiments, the apparatus is configured to mark the corresponding cache line in response to an allocation of the line that causes an overflow counter to increment when it is above a threshold value. In some embodiments, when saturation of to an overflow counter is imminent, the apparatus is configured to flush marked cache lines (e.g., rather than entire caches) to mitigate the saturation situation.

### BRIEF DESCRIPTION OF THE DRAWINGS

FIG. 1 is a block diagram illustrating an exemplary snoop filter for a cluster of processor cores, according to some embodiments.

FIG. 2 is a block diagram illustrating a more detailed view of exemplary snoop filter circuitry with overflow counters, according to some embodiments.

FIG. 3 is a block diagram illustrating an exemplary Bloom filter, according to some embodiments.

FIG. 4 is a block diagram illustrating an exemplary counting Bloom filter, according to some embodiments.

FIG. 5 is a block diagram illustrating an exemplary counting Bloom filter with an overflow array, according to some embodiments.

FIG. 6 is a block diagram illustrating an exemplary overflow marker field for cache lines, according to some embodiments.

FIG. 7 is a flow diagram illustrating an exemplary method for filtering snoops, according to some embodiments.

FIG. 8 is a block diagram illustrating an exemplary processor core, according to some embodiments.

FIG. 9 is a block diagram illustrating an exemplary processor that includes multiple cores, according to some embodiments.

FIG. 10 is a block diagram illustrating an exemplary computer-readable medium, according to some embodiments.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

This specification includes references to “one embodiment,” “an embodiment,” “one implementation,” or “an implementation.” The appearances of these phrases do not necessarily refer to the same embodiment or implementation. Particular features, structures, or characteristics may be combined in any suitable manner consistent with this disclosure.

As used herein, the term “based on” is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component.

As used herein, the term “computer-readable medium” refers to a non-transitory (tangible) medium that is readable by a computer or computer system, and includes magnetic, optical, and solid-state storage media such as hard drives, optical disks, DVDs, volatile or nonvolatile RAM devices, holographic storage, programmable memory, etc. This term specifically does not include transitory (intangible) media (e.g., a carrier wave).

### DETAILED DESCRIPTION

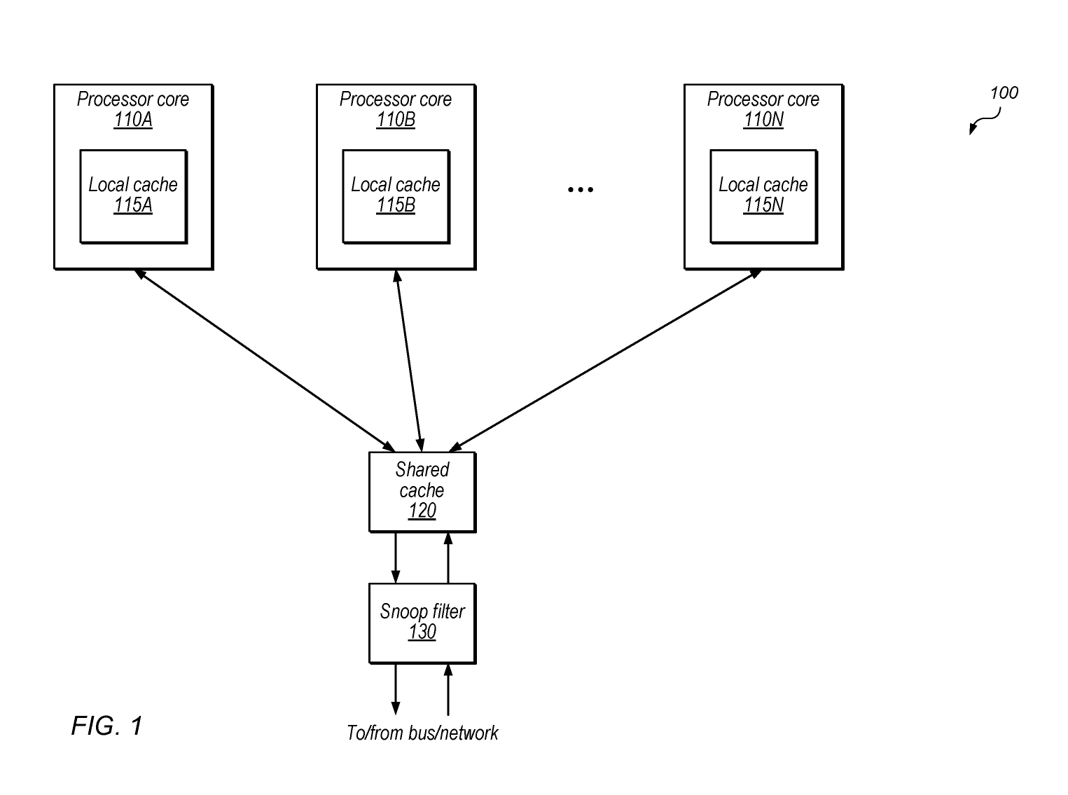

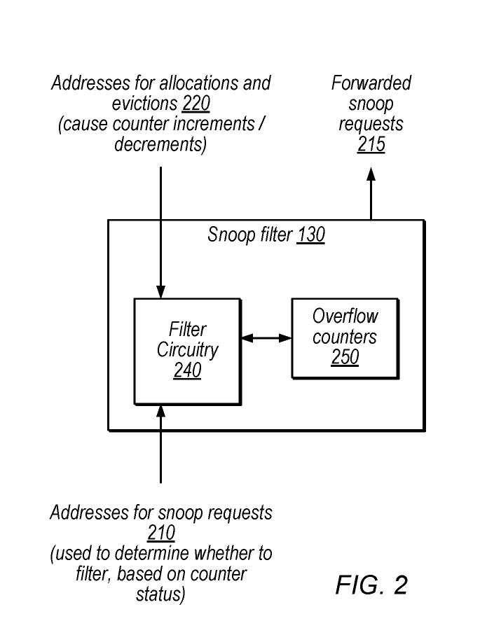

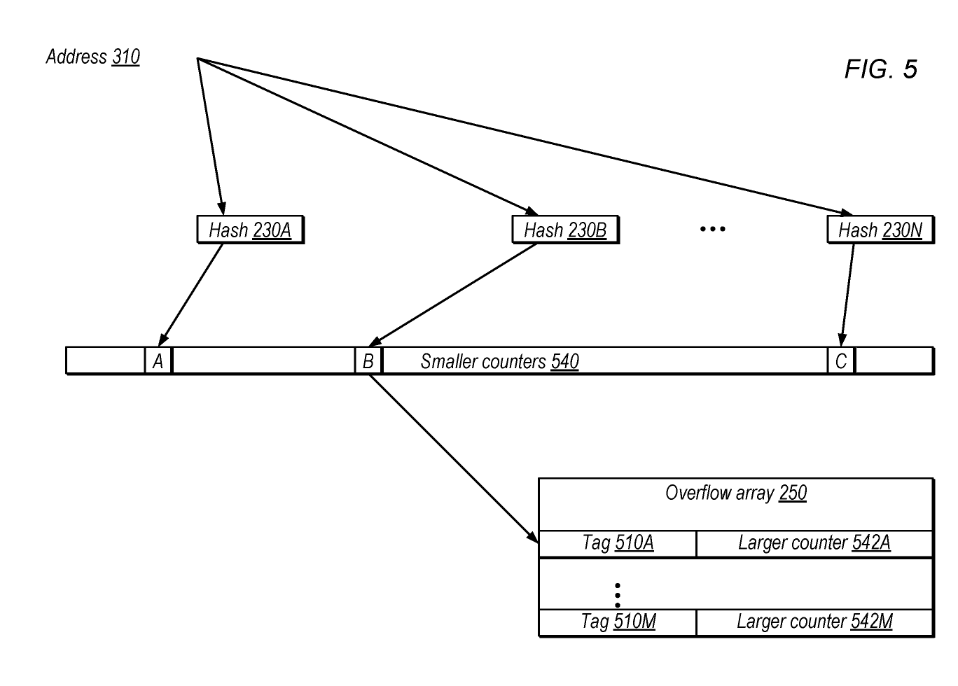

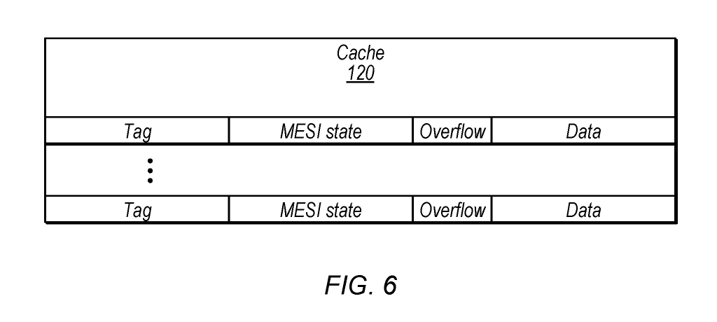

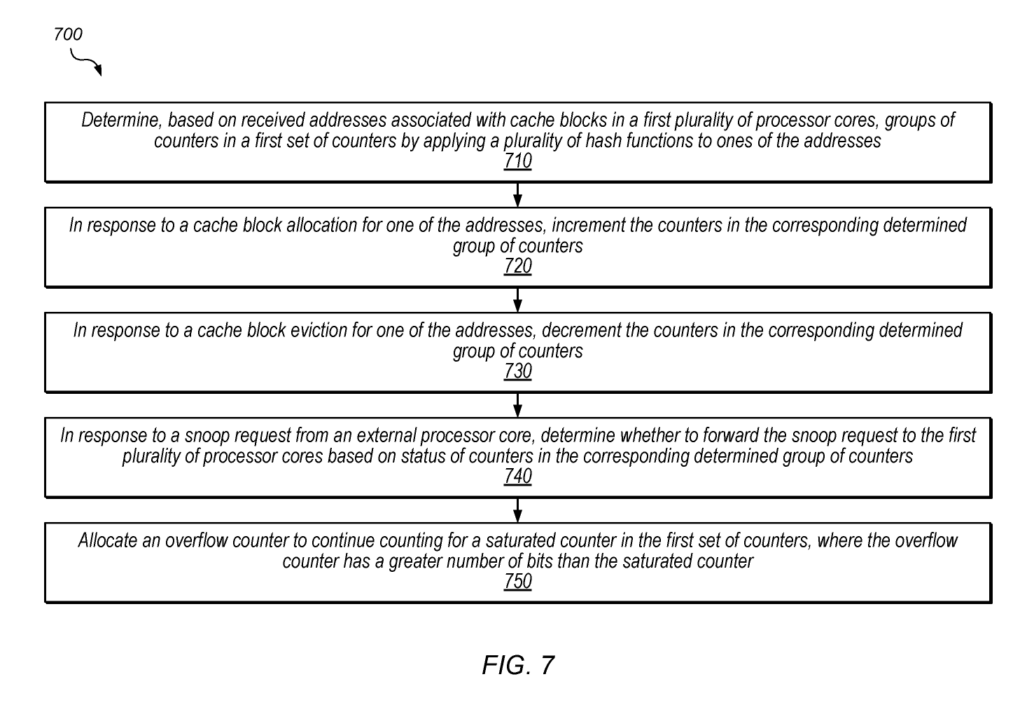

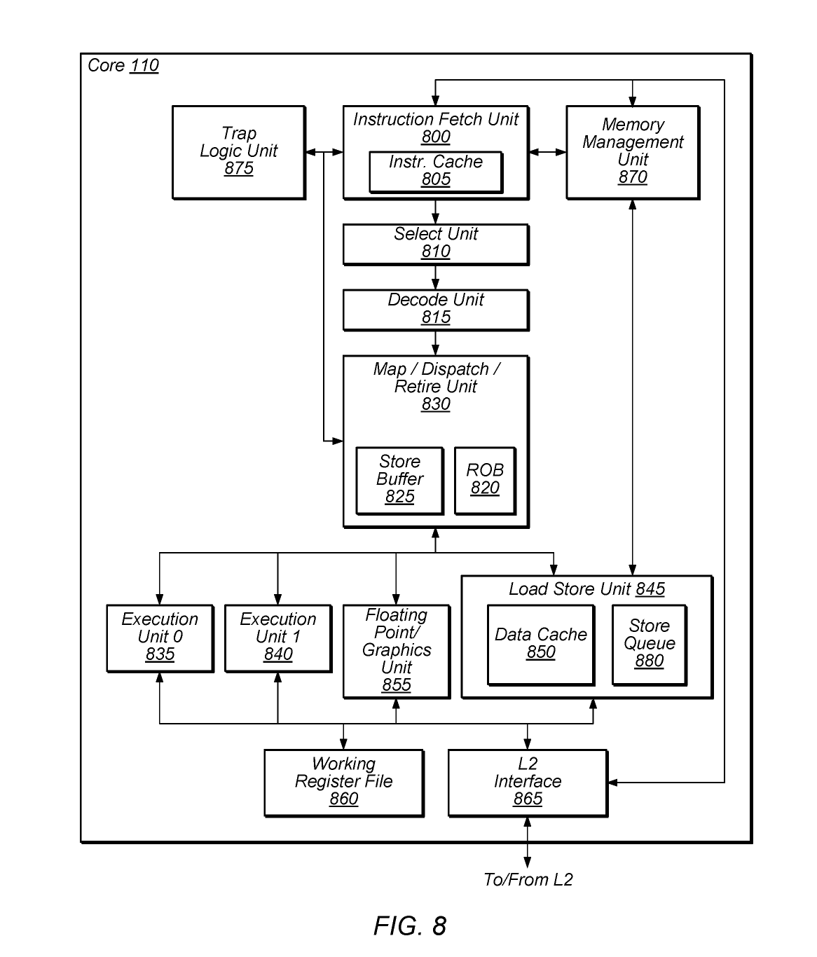

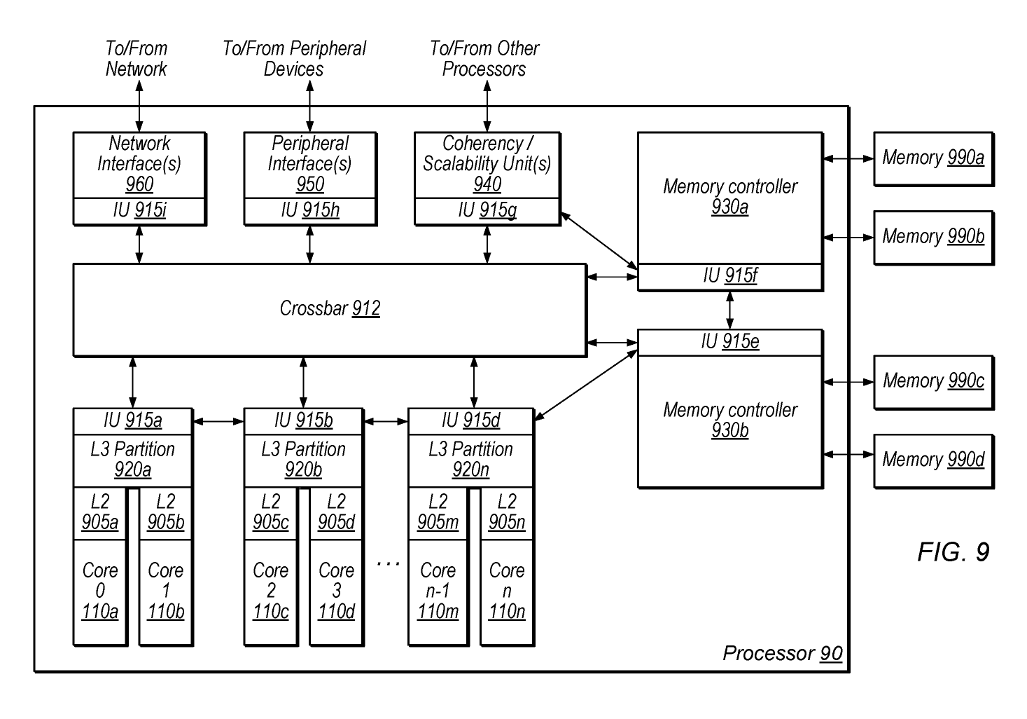

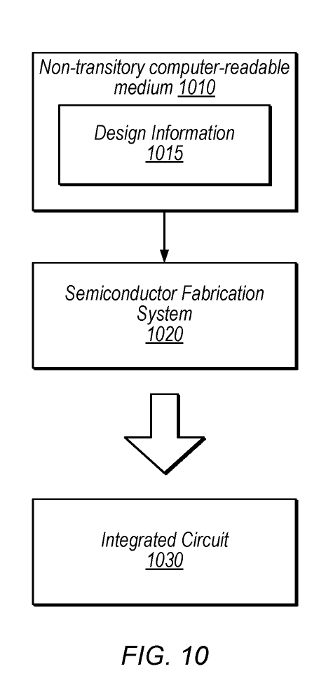

This disclosure initially describes, with reference to FIG. 1, an overview of snoop filter functionality. Embodiments of internal snoop filter circuitry are shown in FIGS. 2-5 (FIG. 5 shows a snoop filter with a counting bloom filter and an overflow array, according to some embodiments). FIG. 6 illustrates an exemplary technique for marking cache lines to mitigate saturation in the overflow array. FIG. 7 illustrates an exemplary method, FIG. 8 illustrates an exemplary processor core, FIG. 9 illustrates an exemplary processor, and FIG. 10 illustrates an exemplary computer-readable medium. In various embodiments, the disclosed techniques may advantageously reduce area and power consumption of snoop filter circuitry and/or improve processor performance.

### Overview of Snoop Filtering

FIG. 1 illustrates a cluster 100 of processing cores, according to some embodiments. In the illustrated embodiment, cluster 100 is coupled to other cores, processors, and/or clusters via a bus or network. In the illustrated embodiment, cluster 100 includes a number of processor cores 110A-110N a shared cache 120, and a snoop filter 130. Each processor 110, in the illustrated embodiment, includes a local cache 115. In various embodiments, each local cache may be divided into separate instruction cache and a data caches (not explicitly shown). Further, each processor core may include multiple local cache levels, in some embodiments.

Shared cache 120, in the illustrated embodiment, is accessible to multiple processor cores 110. In some embodiments, shared cache 120 is always inclusive of the data in the local caches 115 such that any line that is present in a cache 115 is guaranteed to be present in shared cache 120. In these embodiments, snoop requests may be handled by determining whether corresponding data is stored in shared cache 120 without considering caches 115. In other embodiments, snoop requests may be handled by determining whether corresponding data is stored in any of caches 115 and 120.

The term “snoop” is intended to be construed according to its well-understood meaning in the art, which includes monitoring (e.g., of an address bus or a network connection) for notifications that data (e.g., a cache block such as a cache line) has been changed. For example, a core may broadcast data indicating changes to cached data or other cores may simply observe data traffic to detect modifications. Based on snooping, cores may invalidate their local copies when another core modifies corresponding data and/or may update their local copy with the modified data, in various implementations.

In multi-core and multi-processor systems, the number of snoop requests may be substantial and handling these requests may consume power and reduce performance. The term “snoop request” broadly includes various types of observed transactions that indicate a change to cached data by another processor core.

Snoop filter 130, in the illustrated embodiment, is configured to filter snoop requests such that cluster 100 need not handle all snoop requests on the bus or network (e.g., from other clusters). For example, if snoop filter 130 determines that modified data is not present in cluster 100, then it need not forward the corresponding snoop request. In some embodiments, snoop filter 130 is configured to implement a filter such as a Bloom filter to determine whether data is present in caches in cluster 100. Such filters have the property that false positives are possible (e.g., snoop filter 130 may occasionally forward a snoop request when corresponding data is not actually cached in cluster 100), but false negatives cannot occur during correct operation. In other words, such a filter indicates whether data is “possibly present” or “not present.” Such a filter may be implemented using less processor area and may use less power than exact filter implementations that allow no false positives and no false negatives. In some embodiments, even such techniques may still result in large area requirements for sufficiently sized counters, as discussed in further detail below. Therefore, overflow counters are utilized in some embodiments, according to the present disclosure.

FIG. 2 is a block diagram illustrating components of snoop filter 130, according to some embodiments. In the illustrated embodiment, snoop filter 130 is configured to receive addresses for snoop requests 210 and to use the addresses to determine whether to filter the snoop requests (e.g., whether to forward snoop requests (shown as 215 in FIG. 2) or to simply ignore snoop requests). In some embodiments, this determination is based on counters in filter circuitry 240.

In the illustrated embodiment, snoop filter 130 is also configured to receive addresses for allocations and evictions 220 and to use this information to determine when to increment or decrement counters in filter circuitry 240. These counters may be used to track whether corresponding data is possibly cached in cluster 100.

Snoop requests 210 may be from external processors or cores. The term “external,” in the context of a snoop filter, refers to a processor or core for which the filtering circuitry is not configured to track cache block allocations and evictions. For example, the cores 110 in cluster 100 are internal, from the point of view of snoop filter 130, while other processor cores are external.

Overflow counters 250, in the illustrated embodiment, are configured to continue counting for counters in filter circuitry 240 that have saturated, as discussed in further detail below with reference to FIG. 5.

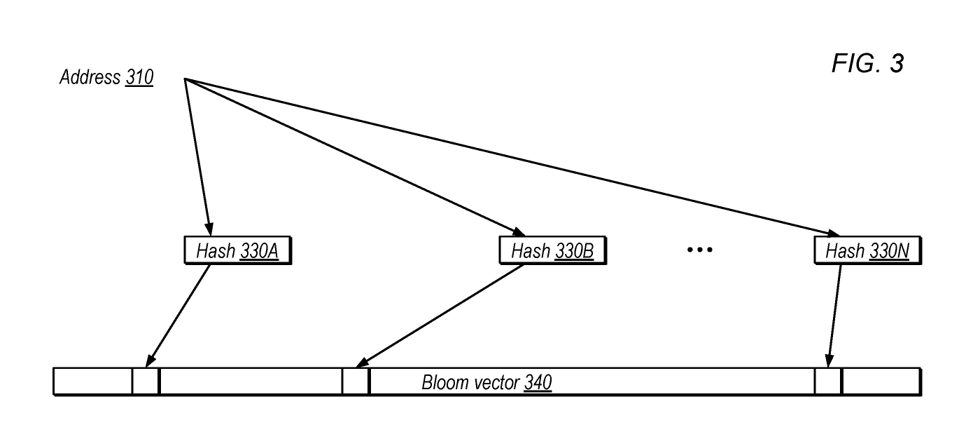

FIG. 3 is a block diagram illustrating an overview of Bloom filtering. In the illustrated embodiment, the Bloom filter includes a number of independent hash functions 330A-330N and a vector 340 of bits initially cleared. When an address 310 is received for a block of data (e.g., a cache line) allocated in a cache in cluster 100, each hash function 330 produces an index in vector 340 (e.g., between zero and N−1 where N is the size of vector 340). These bits are set upon allocation of the block at the provided address. To determine whether data for an address is cached, the address can be used to read the corresponding entries in the vector and determine whether they are set. The likelihood of false positives may be related to the number of hashes used and to the ratio of the number of bits in the vector and the number of blocks in the cache. Both of these values may vary in various embodiments. Evictions of cache blocks, however, may not be representable using the implementation of FIG. 3. Therefore, counting Bloom filters are used in some embodiments.

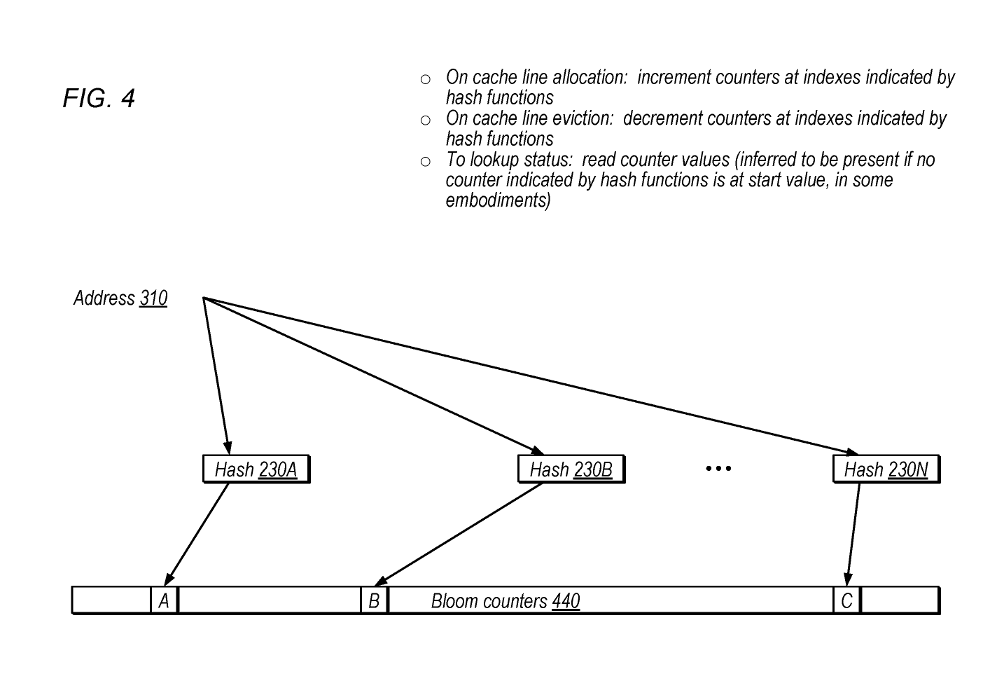

FIG. 4 is a block diagram illustrating an exemplary counting Bloom filter, according to some embodiments. In some embodiments, the circuitry shown in FIG. 4 is included in filter circuitry 240. The indexes may be determined using hash functions 230 in FIG. 4 similarly to the techniques discussed above with reference to FIG. 3. In the embodiment of FIG. 4, however, each index in an array of bloom counters 440 corresponds to a counter. In the illustrated example, address 310 is hashed to at least counters A, B, and C.

In the illustrated embodiment, on allocation of a cache line, the snoop filter 130 increments the counters indicated by the hash functions 230. Similarly, on eviction of a cache line, snoop filter 130 decrements the indicated counters. In the illustrated embodiment, to lookup status for a snoop request, filtering circuitry 130 is configured to read the counter values (of the counters indicated by hashing the snoop address) and infer that corresponding data is cached in cluster 100 if all of the counters are not at a start value (e.g., non-zero).

As used herein, the terms “increment” and “decrement” are not intended to imply a particular direction of counting. Rather, these terms are used together to refer to counting in different directions such that incrementing moves the count value further from a start value and decrementing moves the count value closer to the start value. For example, if the start value is zero, then incrementing refers to counting up toward a maximum value that the counter can represent and decrementing refers to counting back down towards zero. As another example, if the start value is the maximum value that the counter can represent, then incrementing refers to counting down towards zero (saturation in this implementation) and decrementing refers to counting up towards the maximum value.

Because a given counter may be incremented by multiple different addresses, counters may overflow if a counter has insufficient bits. For example, a 2-bit counter allows counting from 0 to 3 but saturates if there is a need to count past 4 or allows counting from 3 to 0 but saturates if there is a need to count past zero. When a counter overflows, a cache flush and clearing of the counters may be needed, which may be time-consuming and reduce performance. Further, using counters of a sufficient size to avoid frequent overflows may require significant chip area. Therefore, in some embodiments, overflow counters are implemented.

FIG. 5 is a block diagram illustrating a more detailed view of a snoop filter that includes an overflow array 250, according to some embodiments. Note that although N hashes are shown in FIGS. 3-5, any of various numbers of hashes may be implemented, including two hashes, for example.

In the illustrated embodiment, when a cache line is allocated and one of the corresponding smaller counters 540 is already saturated (counter B in the example of FIG. 5), snoop filter 130 is configured to allocate an entry in overflow array 250 with a larger counter 542. In the illustrated embodiment, snoop filter 130 tags the larger counter with the index of the smaller counter to which it corresponds. In this way, when a saturated counter 540 has a corresponding allocation or eviction, the counters index can be used to determine whether there is an overflow counter 542 allocated in array 250.

When a cache line is allocated for a saturated small counter in array 540, the corresponding large counter 542 is incremented instead. Similarly, when a cache line is evicted for a saturated small counter in array 540, the corresponding large counter 542 is decremented instead (assuming it has not yet reached its start value). Once the large counter 542 reaches its start value, it may be de-allocated and the corresponding small counter 540 may then be decremented on the next eviction.

In some embodiments, for snoop requests, snoop filter 130 may operate as described above with reference to FIG. 4 (e.g., it need not look at the values in overflow array 250 to determine whether to filter a snoop request, but can simply examine the counters in array 540 to determine whether data is present). Further, the disclosed techniques may allow for use of relatively small (e.g., 2 or 3-bit) counters in array 540, reducing overall area. In some embodiments, a smaller number of larger counters 542 are implemented than smaller counters 540, which may allow the larger counters 542 to have a greater number of bits without significantly affecting area and power consumption. This may be achievable by selecting hashing functions and the number of smaller counters such that a small number of counters 540 will have overflowed at a given time. For example, in some embodiments, experiments have shown that an array of 128k small counters may have about 300 counters that overflow and an array of 512k counters may have about 1200 counters that overflow, under example loads.

In some embodiments, the overflow array is fully associative, but other associativity may be implemented in other embodiments. For example, the overflow array may be a 16-way structure with each way having multiple entries. In such an implementation, one or more bits of index may be used to select a row of entries with 16 comparators configured to compare the entries in a way, for example.

Even when implementing larger overflow counters, two overflow scenarios may still occur. First, an overflow counter may itself saturate. Second, if too many small counters saturate, there may be an insufficient number of overflow counters. These scenarios may have a non-zero probability of occurring, even if the counters and overflow array are oversized relative to simulated needs. If either of these scenarios happens, cluster 100 may be configured to flush the caches and reset the small counters and overflow counters to their respective start values. In some embodiments, however, additional information is maintained in order to mitigate these overflow scenarios.

FIG. 6 is a block diagram illustrating a more detailed view of cache 120, according to some embodiments. Similar techniques may be implemented for one or more of any of various caches in a cluster. In the illustrated embodiment, cache lines in cache 120 (shown as “data” in FIG. 6) have the following control information: tag, MESI state, and an overflow field. The tag and MESI fields may be implemented according to well-understood techniques (note that other cache coherency protocols than MESI may also be implemented to indicate cache line state such as MOESI, MERSI, etc.).

The overflow field, in some embodiments, indicates whether a line contributes to an overflow counter that is near its saturation value. For example, this field may be a single bit that indicates whether allocation of the cache line caused incrementation of one or more overflow counters that have reached a threshold value. This field may be set and cleared using cache control packets, for example. Speaking generally, this field may be set for cache lines upon any increment that occurs when an overflow counter has met a predetermined threshold.

In some embodiments, cluster 100 is configured to prioritize eviction of cache lines whose overflow field is set, to avoid overflow situations. Lines with their overflow field may be flushed in response to one or more predetermined types of event. For example, in some embodiments, if a small counter than has saturated is incremented such that a new overflow counter is allocated, cluster 100 is configured to evict and/or invalidate all cache lines with their overflow bit set. Evictions/invalidations may be performed by hardware or using a software interrupt, for example. Another example of an event may be saturation of an overflow counter.

Therefore, broadly speaking, the disclosed techniques may include using small counters in a counting bloom filter and a smaller array of larger counters for filter overflows. The disclosed techniques may reduce area and power consumption (which may advantageously scale less than linearly as cache size increases) and/or improve performance by reducing flushing of cache lines. The advantages may be substantial in larger systems, for example, in with 32, 64, 128, or more processor cores.

FIG. 7 is a flow diagram illustrating an exemplary method 700 for filtering snoops, according to some embodiments. The method shown in FIG. 7 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired.

At 710, in the illustrated embodiment, snoop filter 130 determines, based on received addresses associated with cache blocks in a first plurality of processor cores, groups of counters in a first set of counters by applying a plurality of hash functions to ones of the addresses. For example, snoop filter 130 may use two or more hashes 230 to generate indices of counters in an array of counters. The counters at these indices may be used in different ways, depending on the nature of the operation associated with a given address.

At 720, in the illustrated embodiment, snoop filter 130 increments the counters in the corresponding determined group of counters in response to a cache block allocation for one of the addresses.

At 730, in the illustrated embodiment, snoop filter 130 decrements the counters in the corresponding determined group of counters in response to a cache block eviction for one of the addresses. Note that if this decrement causes one or more of the counters to reach its start value, this may indicate that the cache block is no longer cached by the processor(s) snoop filter 130 is handling.

At 740, in the illustrated embodiment, snoop filter 130 determines determine whether to forward a snoop request to the first plurality of processor cores based on status of counters in the corresponding determined group of counters. For example, snoop filter 130 is configured to block the snoop request, in some embodiments, if one or more of the counters in the group of counters is at its start value.

At 750, in the illustrated embodiment, snoop filter 130 allocates an overflow counter to continue counting for a saturated counter in the first set of counters, where the overflow counter has a greater number of bits than the saturated counter.

In some embodiments, snoop filter 130 increments the overflow counter in response to a cache block allocation when the saturated counter is saturated and decrements the overflow counter in response to a cache block eviction when the saturated counter is saturated. This may ensure that the counter remains accurate, in various embodiments. In some embodiments, snoop filter 130 de-allocates the overflow counter in response to a cache block eviction when the overflow counter is at a start value. In some embodiments, snoop filter 130 marks a cache block in response to allocation of the cache block causing the overflow counter to increment at a point in time in which the overflow counter exceeds a threshold value. The apparatus than may prioritize marked cache blocks for flushing.

### Exemplary Processor Core

Turning now to FIG. 8, an exemplary embodiment of a processor core 110 is shown. In the illustrated embodiment, core 110 includes an instruction fetch unit (IFU) 800 that includes an instruction cache 805. IFU 800 is coupled to a memory management unit (MMU) 870, L2 interface 865, trap logic unit (TLU) 875, and map/dispatch/retire unit 830. IFU 800 is additionally coupled to an instruction processing pipeline that begins with a select unit 810 and proceeds in turn through a decode unit 815, and a map/dispatch/retire unit 830. Map/dispatch/retire unit 830 is coupled to issue instructions to any of a number of instruction execution resources: an execution unit 0 (EXU0) 835, an execution unit 1 (EXU1) 840, a load store unit (LSU) 845 that includes a data cache 850, and/or a floating-point/graphics unit (FGU) 855 in the illustrated example. In this embodiment, these instruction execution resources are coupled to a working register file 860. Additionally, LSU 845 is coupled to L2 interface 865 and MMU 870.

In the following discussion, exemplary embodiments of each of the structures of the illustrated embodiment of core 110 are described. However, it is noted that the illustrated partitioning of resources is merely one example of how core 110 may be implemented. Alternative configurations and variations are possible and contemplated.

Instruction fetch unit 800, in one embodiment, is configured to provide instructions to the rest of core 110 for execution. In one embodiment, IFU 800 may be configured to select a thread to be fetched, fetch instructions from instruction cache 805 for the selected thread and buffer them for downstream processing, request data from an L2 cache in response to instruction cache misses, and predict the direction and target of control transfer instructions (e.g., branches). In some embodiments, IFU 800 may include a number of data structures in addition to instruction cache 805, such as an instruction translation lookaside buffer (ITLB), instruction buffers, and/or structures configured to store state that is relevant to thread selection and processing. In one embodiment, during each execution cycle of core 110, IFU 800 may be configured to select one thread that will enter the IFU processing pipeline. In some embodiments, a given processing pipeline may be configured to execute instructions for multiple threads. Thread selection may take into account a variety of factors and conditions, some thread-specific and others IFU-specific. Any suitable scheme for thread selection may be employed.

Once a thread has been selected for fetching by IFU 800, instructions may actually be fetched for the selected thread. To perform the fetch, in one embodiment, IFU 800 may be configured to generate a fetch address to be supplied to instruction cache 205. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 805 to determine whether there is a cache hit.

In some embodiments, accessing instruction cache 805 may include performing fetch address translation (e.g., in the case of a physically indexed and/or tagged cache), accessing a cache tag array, and comparing a retrieved cache tag to a requested tag to determine cache hit status. If there is a cache hit, IFU 800 may store the retrieved instructions within buffers for use by later stages of the instruction pipeline. If there is a cache miss, IFU 800 may coordinate retrieval of the missing cache data from an L2 cache (not explicitly shown in FIG. 8). In some embodiments, IFU 800 may also be configured to prefetch instructions into instruction cache 805 before the instructions are actually required to be fetched. For example, in the case of a cache miss, IFU 800 may be configured to retrieve the missing data for the requested fetch address as well as addresses that sequentially follow the requested fetch address, on the assumption that the following addresses are likely to be fetched in the near future.

In one embodiment, during any given execution cycle of core 110, select unit 810 may be configured to select one or more instructions from a selected threads for decoding by decode unit 815. In various embodiments, differing number of threads and instructions may be selected. In various embodiments, different conditions may affect whether a thread is ready for selection by select unit 810, such as branch mispredictions, unavailable instructions, or other conditions. To ensure fairness in thread selection, some embodiments of select unit 810 may employ arbitration among ready threads (e.g. a least-recently-used algorithm).

Generally, decode unit 215 may be configured to prepare the instructions selected by select unit 210 for further processing. Decode unit 215 may be configured to identify the particular nature of an instruction (e.g., as specified by its opcode) and to determine the source and sink (i.e., destination) registers encoded in an instruction, if any. In some embodiments, decode unit 815 may be configured to detect certain dependencies among instructions, to remap architectural registers to a flat register space, and/or to convert certain complex instructions to two or more simpler instructions for execution.

Register renaming may facilitate the elimination of certain dependencies between instructions (e.g., write-after-read or “false” dependencies), which may in turn prevent unnecessary serialization of instruction execution. In one embodiment, map/dispatch/retire unit 830 may be configured to rename the logical (i.e., architected) destination registers specified by instructions by mapping them to a physical register space, resolving false dependencies in the process. In some embodiments, map/dispatch/retire unit 830 may maintain mapping tables that reflect the relationship between logical registers and the physical registers to which they are mapped.

Once decoded and renamed, instructions may be ready to be scheduled for execution. In the illustrated embodiment, map/dispatch/retire unit 830 may be configured to pick (i.e., schedule/dispatch) instructions that are ready for execution and send the picked instructions to various execution units. In one embodiment, map/dispatch/retire unit 830 may be configured to maintain a schedule queue that stores a number of decoded and renamed instructions. In one embodiment, ROB 820 is configured to store instructions based on their relative age in order to allow completion of instructions in program order. In some embodiments, speculative results of instructions may be stored in ROB 820 before being committed to the architectural state of core 110, and confirmed results may be committed/retired in program order. Entries in ROB 820 may be marked as ready to commit when their results are allowed to be written to the architectural state. Store instructions may be posted to store queue 880 and retired from ROB 820 before their results have actually been performed in a cache or memory, e.g., as described above with reference to FIG. 1B.

Store buffer 825, in one embodiment, is configured to store information (e.g., store data and target address) for store instructions until they are ready to go through version comparison and be performed, at which point the store instructions are sent to store queue 880.

Map/dispatch/retire unit 830 may be configured to provide instruction sources and data to the various execution units for picked instructions. In one embodiment, map/dispatch/retire unit 830 is configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 110 includes a working register file 860 that may be configured to store instruction results (e.g., integer results, floating-point results, and/or condition code results) that have not yet been committed to architectural state, and which may serve as the source for certain operands. The various execution units may also maintain architectural integer, floating-point, and condition code state from which operands may be sourced.

Instructions issued from map/dispatch/retire unit 830 may proceed to one or more of the illustrated execution units for execution. In one embodiment, each of EXU0 835 and EXU1 840 may be similarly or identically configured to execute certain integer-type instructions defined in the implemented ISA, such as arithmetic, logical, and shift instructions. In the illustrated embodiment, EXU0 835 may be configured to execute integer instructions issued from slot 0, and may also perform address calculation and for load/store instructions executed by LSU 845. EXU1 840 may be configured to execute integer instructions issued from slot 1, as well as branch instructions. In one embodiment, FGU instructions and multicycle integer instructions may be processed as slot 1 instructions that pass through the EXU1 840 pipeline, although some of these instructions may actually execute in other functional units.

In some embodiments, architectural and non-architectural register files may be physically implemented within or near execution units 835-840. It is contemplated that in some embodiments, core 110 may include more or fewer than two integer execution units, and the execution units may or may not be symmetric in functionality. Also, in some embodiments, execution units 835-840 may not be bound to specific issue slots, or may be differently bound than just described.

Load store unit 845 may be configured to process data memory references, such as integer and floating-point load and store instructions and other types of memory reference instructions. LSU 845 may include a data cache 850 as well as logic configured to detect data cache misses and to responsively request data from an L2 cache. In one embodiment, data cache 850 may be configured as a set-associative, write-through cache in which all stores are written to the L2 cache regardless of whether they hit in data cache 850. In this embodiment, store instructions may be complete when their results are written to the L2 cache. In this embodiment, processor 10 may retrieve version information from L2 cache for comparison with version information associated with versioned store instructions. As noted above, the actual computation of addresses for load/store instructions may take place within one of the integer execution units, though in other embodiments, LSU 845 may implement dedicated address generation logic. In some embodiments, LSU 845 may implement an adaptive, history-dependent hardware prefetcher configured to predict and prefetch data that is likely to be used in the future, in order to increase the likelihood that such data will be resident in data cache 850 when it is needed.

In various embodiments, LSU 845 may implement a variety of structures configured to facilitate memory operations. For example, LSU 845 may implement a data TLB to cache virtual data address translations. LSU 845 may include a miss buffer configured to store outstanding loads and stores that cannot yet complete, for example due to cache misses. In the illustrated embodiment, LSU 845 includes store queue 880 configured to store address and data information for stores, in order to facilitate load dependency checking and provide data for version comparison. LSU 845 may also include hardware configured to support atomic load-store instructions, memory-related exception detection, and read and write access to special-purpose registers (e.g., control registers).

Floating-point/graphics unit 855 may be configured to execute and provide results for certain floating-point and graphics-oriented instructions defined in the implemented ISA. For example, in one embodiment FGU 855 may implement single- and double-precision floating-point arithmetic instructions compliant with the IEEE 754-1985 floating-point standard, such as add, subtract, multiply, divide, and certain transcendental functions. Also, in one embodiment FGU 855 may implement partitioned-arithmetic and graphics-oriented instructions. Additionally, in one embodiment FGU 855 may implement certain integer instructions such as integer multiply, divide, and population count instructions. Depending on the implementation of FGU 855, some instructions (e.g., some transcendental or extended-precision instructions) or instruction operand or result scenarios (e.g., certain denormal operands or expected results) may be trapped and handled or emulated by software.

During the course of operation of some embodiments of core 110, exceptional events may occur. For example, an instruction from a given thread that is selected for execution by select unit 810 may not be a valid instruction for the ISA implemented by core 110 (e.g., the instruction may have an illegal opcode), a floating-point instruction may produce a result that requires further processing in software, MMU 870 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 875 may be configured to manage the handling of such events. TLU 875 may also be configured to coordinate thread flushing that results from branch misprediction or exceptions. For instructions that are not flushed or otherwise cancelled due to mispredictions or exceptions, instruction processing may end when instruction results have been committed and/or performed.

In various embodiments, any of the units illustrated in FIG. 8 may be implemented as one or more pipeline stages, to form an instruction execution pipeline that begins when thread fetching occurs in IFU 800 and ends with result commitment by map/dispatch/retire unit 830. Depending on the manner in which the functionality of the various units of FIG. 8 is partitioned and implemented, different units may require different numbers of cycles to complete their portion of instruction processing. In some instances, certain units (e.g., FGU 855) may require a variable number of cycles to complete certain types of operations. In some embodiments, a core 110 includes multiple instruction execution pipelines.

### Processor Overview

Turning now to FIG. 9, a block diagram illustrating one exemplary embodiment of processor 90 is shown. In the illustrated embodiment, processor 90 includes a number of processor cores 110a-n, which are also designated “core 0” though “core n.” As used herein, the term “processor” may refer to an apparatus having a single processor core or an apparatus that includes two or more processor cores. Various embodiments of processor 90 may include varying numbers of cores 110, such as 8, 16, or any other suitable number. In the illustrated embodiment, each of cores 110 is coupled to a corresponding L2 cache 905a-n, which in turn couple to L3 cache partitions 920a-n via interface units (IU) 915a-d. Cores 110a-n, L2 caches 905a-n, L3 partitions 920a-n, and interface units 915a-i may be generically referred to, either collectively or individually, as core(s) 110, L2 cache(s) 905, L3 partition(s) 920 and IU(s) 915, respectively. The organization of elements in FIG. 9 is exemplary only; in other embodiments the illustrated elements may be arranged in a different manner and additional elements may be included in addition to and/or in place of the illustrated processing elements.

Via IUs 915 and/or crossbar 912, cores 110 may be coupled to a variety of other devices that may be located externally to processor 90. In the illustrated embodiment, memory controllers 930a and 930b are configured to couple to memory banks 990a-d. One or more coherency/scalability unit(s) 940 may be configured to couple processor 90 to other processors (e.g., in a multiprocessor environment employing multiple units of processor 90). Additionally, crossbar 912 may be configured to couple cores 110 to one or more peripheral interface(s) 950 and network interface(s) 960. As described in greater detail below, these interfaces may be configured to couple processor 90 to various peripheral devices and networks.

As used herein, the term “coupled to” may indicate one or more connections between elements, and a coupling may include intervening elements. For example, in FIG. 9, IU 915f may be described as “coupled to” IU 915b through IUs 915d and 955e and/or through crossbar 912. In contrast, in the illustrated embodiment of FIG. 9, IE 915f is “directly coupled” to IU 915e because there are no intervening elements.

Cores 110 may be configured to execute instructions and to process data according to a particular instruction set architecture (ISA). In various embodiments it is contemplated that any desired ISA may be employed.

As shown in FIG. 9, in one embodiment, each core 110 may have a dedicated corresponding L2 cache 905. In one embodiment, L2 cache 905 may be configured as a set-associative, write-back cache that is fully inclusive of first-level cache state (e.g., instruction and data caches within core 110). To maintain coherence with first-level caches, embodiments of L2 cache 905 may implement a reverse directory that maintains a virtual copy of the first-level cache tags. L2 cache 905 may implement a coherence protocol (e.g., the MESI protocol) to maintain coherence with other caches within processor 90. In some embodiments (not shown), each core 110 may include separate L2 data and instruction caches. Further, in some embodiments, each core 110 may include multiple execution pipelines each with associated L1 data and instruction caches. In these embodiments, each core 110 may have multiple dedicated L2 data and/or instruction caches. In the illustrated embodiment, caches are labeled according to an L1, L2, L3 scheme for convenience, but in various embodiments, various cache hierarchies may be implemented having various numbers of levels and various sharing or dedication schemes among processor cores.

Crossbar 912 and IUs 915 may be configured to manage data flow between elements of processor 90. In one embodiment, crossbar 912 includes logic (such as multiplexers or a switch fabric, for example) that allows any L2 cache 905 to access any partition of L3 cache 920, and that conversely allows data to be returned from any L3 partition 920. That is, crossbar 912 may be configured as an M-to-N crossbar that allows for generalized point-to-point communication. However, in other embodiments, other interconnection schemes may be employed. For example, a mesh, ring, or other suitable topology may be utilized. In the illustrated embodiment, IUs 915a-g are also coupled according to a ring topology. Thus, via IUs 915a-g, any L2 cache 905 may access any partition of L3 cache 920 via one of more of IUs 915 a-g. In various embodiments, various interconnections schemes may be employed between various elements of processor 90. The exemplary embodiment of FIG. 9 is intended to illustrate one particular implementation, but other implementations are contemplated.

In some embodiments, crossbar 912 and/or IUs 915 may include logic to queue data requests and/or responses, such that requests and responses may not block other activity while waiting for service. Additionally, in one embodiment, crossbar 912 and/or IUs 915 may be configured to arbitrate conflicts that may occur when multiple elements attempt to access a single L3 partition 920.

L3 cache 920 may be configured to cache instructions and data for use by cores 110. In the illustrated embodiment, L3 cache 920 is organized into multiple separately addressable partitions that may each be independently accessed, such that in the absence of conflicts, each partition may concurrently return data to one or more respective L2 caches 905. In some embodiments, each individual partition may be implemented using set-associative or direct-mapped techniques. For example, in one embodiment, each L3 partition 920 may be an 8 megabyte (MB), 16-way set associative partition with a 64-byte line size. L3 partitions 920 may be implemented in some embodiments as a write-back cache in which written (dirty) data may not be written to system memory until a corresponding cache line is evicted. However, it is contemplated that in other embodiments, L3 cache 920 may be configured in any suitable fashion. For example, L3 cache 920 may be implemented with more or fewer partitions, or in a scheme that does not employ independently-accessible partitions; it may employ other partition sizes or cache geometries (e.g., different line sizes or degrees of set associativity); it may employ write through instead of write-back behavior; and it may or may not allocate on a write miss. Other variations of L3 cache 920 configuration are possible and contemplated.

In some embodiments, L3 cache 920 implements queues for requests arriving from and results to be sent to crossbar 912 and/or IUs 915. Additionally, L3 cache 920 may implement a fill buffer configured to store fill data arriving from memory controller 930, a write-back buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 partitions 920 may variously be implemented as single-ported or multiported (i.e., capable of processing multiple concurrent read and/or write accesses). In either case, L3 cache 920 may implement arbitration logic to prioritize cache access among various cache read and write requestors.

Memory controllers 930a-b may be configured to manage the transfer of data between L3 partitions 920 and system memory, for example in response to cache fill requests and data evictions. Memory controller 930 may receive read and write requests and translate them into appropriate command signals to system memory. Memory controller 930 may refresh the system memory periodically in order to avoid loss of data. Memory controller 930 may be configured to read or write from the memory by selecting row and column data addresses of the memory. Memory controller 930 may be configured to transfer data on rising and/or falling edges of a memory clock. In some embodiments, any number of instances of memory interface 930 may be implemented, with each instance configured to control respective one or more banks of system memory. Memory interface 930 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 930 may be configured to support interfacing to multiple different types of system memory. In the illustrated embodiment, memory controller 930 is included in processor 90. In other embodiments, memory controller 930 may be located elsewhere in a computing system, e.g., included on a circuit board or system-on-a-chip and coupled to processor 90.

Processor 90 may be configured for use in a multiprocessor environment with other instances of processor 90 or other compatible processors. In the illustrated embodiment, coherency/scalability unit (s) 940 may be configured to implement high-bandwidth, direct chip-to-chip communication between different processors in a manner that preserves memory coherence among the various processors (e.g., according to a coherence protocol that governs memory transactions). In some embodiments, a snoop unit 130 may be included in each processor 90. In other embodiments, snoop unit 130 may filter snoops for multiple processors or for only a portion of the cores 110 in processor 90.

Peripheral interface 950 may be configured to coordinate data transfer between processor 90 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 950 may implement one or more instances of a standard peripheral interface. For example, one embodiment of peripheral interface 950 may implement the Peripheral Component Interface Express (PCI-Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments peripheral interface 950 may be configured to implement a version of Universal Serial Bus (USB) protocol or IEEE 1394 (Firewire®) protocol in addition to or instead of PCI-Express™.

Network interface 960 may be configured to coordinate data transfer between processor 90 and one or more network devices (e.g., networked computer systems or peripherals) coupled to processor 90 via a network. In one embodiment, network interface 960 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 960 may be configured to implement other types of networking protocols, such as Fibre Channel, Fibre Channel over Ethernet (FCoE), Data Center Ethernet, Infiniband, and/or other suitable networking protocols. In some embodiments, network interface 960 may be configured to implement multiple discrete network interface ports.

FIG. 10 is a block diagram illustrating an exemplary non-transitory computer-readable storage medium that stores circuit design information, according to some embodiments. In the illustrated embodiment semiconductor fabrication system 1020 is configured to process the design information 1015 stored on non-transitory computer-readable medium 1010 and fabricate integrated circuit 1030 based on the design information 1015.

Non-transitory computer-readable medium 1010, may comprise any of various appropriate types of memory devices or storage devices. Medium 1010 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Medium 1010 may include other types of non-transitory memory as well or combinations thereof. Medium 1010 may include two or more memory mediums which may reside in different locations, e.g., in different computer systems that are connected over a network.

Design information 1015 may be specified using any of various appropriate computer languages, including hardware description languages such as, without limitation: VHDL, Verilog, SystemC, SystemVerilog, RHDL, M, MyHDL, etc. Design information 1015 may be usable by semiconductor fabrication system 1020 to fabrication at least a portion of integrated circuit 1030. The format of design information 1015 may be recognized by at least one semiconductor fabrication system 1020. In some embodiments, design information 1015 may also include one or more cell libraries which specify the synthesis and/or layout of integrated circuit 1030. In some embodiments, the design information is specified in whole or in part in the form of a netlist that specifies cell library elements and their connectivity.

Semiconductor fabrication system 1020 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1020 may also be configured to perform various testing of fabricated circuits for correct operation.

In various embodiments, integrated circuit 1030 is configured to operate according to a circuit design specified by design information 1015, which may include performing any of the functionality described herein. For example, integrated circuit 1030 may include any of various elements shown in FIGS. 1-6 and/or 8-9. Further, integrated circuit 1030 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a first plurality of processor cores;
filter circuitry comprising a first set of counters each having a first number of bits, wherein the filter circuitry is configured to, in response to an incoming address:
determine a group of counters in the first set of counters based on applying a plurality of hash functions to the address;
in response to a cache block allocation by one of the first plurality of processor cores at the address, increment the counters in the group of counters;
in response to a cache block eviction by one of the first plurality of processor cores at the address, decrement the counters in the group of counters; and
in response to a snoop request from another processor core, determine whether to forward the snoop request to the first plurality of processor cores based on status of counters in the group of counters; and
overflow circuitry comprising a second set of counters each having a second number of bits that is greater than the first number of bits, wherein the apparatus is configured to allocate an overflow counter in the second set of counters to continue counting for a saturated counter in the first set of counters.

2. The apparatus of claim 1, wherein the apparatus is configured to:
increment the overflow counter in response to a cache block allocation when the saturated counter is saturated; and
decrement the overflow counter in response to a cache block eviction when the saturated counter is saturated.

3. The apparatus of claim 1, wherein the apparatus is configured to de-allocate the overflow counter in response to a cache block eviction when the overflow counter is at a start value.

4. The apparatus of claim 1, wherein the apparatus is configured to tag the overflow counter with an index of the saturated counter.

5. The apparatus of claim 1, wherein the apparatus is configured to mark a cache block in response to allocation of the cache block causing the overflow counter to increment at a point in time in which the overflow counter exceeds a threshold value.

6. The apparatus of claim 5, wherein the apparatus is configured to evict marked cache blocks in response to a particular event.

7. The apparatus of claim 6, wherein the particular event is saturation of the overflow counter.

8. The apparatus of claim 1, wherein the second set of counters is smaller in number than the first set of counters.

9. The apparatus of claim 1, wherein the plurality of hash functions implement a Bloom filter.

10. The apparatus of claim 1, wherein the filter circuitry is configured to block snoop requests in response to determining that at least one of the counters in the corresponding determined group of counters has a start value.

11. A non-transitory computer readable storage medium having stored thereon design information that specifies a design of at least a portion of a hardware integrated circuit in a format recognized by a semiconductor fabrication system that is configured to use the design information to produce the circuit according to the design, including:
filter circuitry comprising a first set of counters each having a first number of bits, wherein the filter circuitry is configured to, in response to an incoming address associated with a cache block of a first plurality of processor cores:
determine a group of counters in the first set of counters based on applying a plurality of hash functions to the address;
in response to a cache block allocation by one of the first plurality of processor cores at the address, increment the counters in the group of counters;
in response to a cache block eviction by one of the first plurality of processor cores at the address, decrement the counters in the group of counters; and
in response to a snoop request from another processor core, determine whether to forward the snoop request to the first plurality of processor cores based on status of counters in the group of counters; and
overflow circuitry comprising a second set of counters each having a second number of bits that is greater than the first number of bits, wherein the circuit is configured to allocate an overflow counter in the second set of counters to continue counting for a saturated counter in the first set of counters.

12. The non-transitory computer readable storage medium of claim 11, wherein the design information further specifies that the circuit is configured to increment the overflow counter in response to a cache block allocation when the saturated counter is saturated and decrement the overflow counter in response to a cache block eviction when the saturated counter is saturated.

13. The non-transitory computer readable storage medium of claim 11, wherein the design information further specifies that the circuit is configured to de-allocate the overflow counter in response to a cache block eviction when the overflow counter is at a start value.

14. The non-transitory computer readable storage medium of claim 11, wherein the design information further specifies that the circuit is configured to tag the overflow counter with an index of the saturated counter.

15. The non-transitory computer readable storage medium of claim 11, wherein the design information further specifies that the circuit is configured to mark a cache block in response to allocation of the cache block causing the overflow counter to increment at a point in time in which the overflow counter exceeds a threshold value.

16. A method, comprising:
determining, based on received addresses associated with cache blocks in a first plurality of processor cores, groups of counters in a first set of counters by applying a plurality of hash functions to ones of the addresses;
in response to a cache block allocation for one of the addresses, incrementing the counters in the corresponding determined group of counters;
in response to a cache block eviction for one of the addresses, decrementing the counters in the corresponding determined group of counters;
in response to a snoop request from an external processor core, determining whether to forward the snoop request to the first plurality of processor cores based on status of counters in the corresponding determined group of counters; and
allocating an overflow counter to continue counting for a saturated counter in the first set of counters, wherein the overflow counter has a greater number of bits than the saturated counter.

17. The method of claim 16, further comprising:
incrementing the overflow counter in response to a cache block allocation when the saturated counter is saturated; and
decrementing the overflow counter in response to a cache block eviction when the saturated counter is saturated.

18. The method of claim 16, further comprising:
de-allocating the overflow counter in response to a cache block eviction when the overflow counter is at a start value.

19. The method of claim 16, further comprising marking a cache block in response to allocation of the cache block causing the overflow counter to increment at a point in time in which the overflow counter exceeds a threshold value.

20. The method of claim 16, further comprising blocking a snoop request in response to determining that at least one of the counters in the group of counters for the snoop request has a start value.
